(19) United States
(12) Patent Application Publication
(10) Pub. No.: US 2005/0015273 A1
(43) Pub. Date: Jan. 20, 2005

(54) Warranty management and analysis system

(76) Inventor: Supriya Iyer, Los Altos, CA (US)

Correspondence Address: KENYON & KENYON, 1500 K STREET, N.W., SUITE 700, WASHINGTON, DC, 20005, US

(21) Appl. No.: 10/885,866

(22) Filed: Jul. 8, 2004

Related U.S. Application Data
(60) Provisional application No. 60/486,893, filed on Jul. 15, 2003.

(51) Int. Cl. G06F 17/60

(52) U.S. Cl. 705/1

(57) ABSTRACT

A warrantor computer system provides automated support functions that permit new and existing customers to enter into warranty agreements, alter existing warranty agreements or change customer profiles to identify new products subject to warranties. The warranty management system further provides a defect analysis and resolution service that compiles warranty claims for statistical analysis to identify product defects. Additionally, the warranty management system provides a service partner enabling service that manages services of partners performed pursuant to a warranty.

### BACKGROUND

The present invention relates to automated services provided by a computer server to manage warranty programs offered by firms.

Most modern firms typically rely on computer systems to manage their business processes. These business processes may manage sales and delivery of goods, purchases of supplies and other basic operations performed by the firm. As firm personnel interact with these processes, the firm's computer systems develop electronic records of firm operation which builds a base of data from which to model and analyze firm operations. However to have a highly cost efficient business model, many firms are outsourcing some service-related operations to third parties. Although the service operations may be outsourced to others, the outsourcing firm still must manage the operations to ensure they are being performed as designed. These firms have to ensure that the third parties are performing as expected while delivering the benefits of outsourcing. As a result they need a mechanism to track the external service provider performance. This is made possible by maintaining and automating their service level agreements and comparing them against the warranty service related transactional data.

Although some automated systems provide rudimentary warranty management services, such as a claims management system, no known solution provides a comprehensive warranty management system to provide sales and upgrades of warranty contracts, compile and analyze warranty claims data for product defect analysis or program revenue analysis or to manage service partners and others in fulfillment of warranty policies. The inventor perceives a need in the art for such a solution.

### BRIEF DESCRIPTION OF THE DRAWINGS

FIG. 1 is a simplified block diagram of a networked computer system useful with embodiments of the present invention.

FIG. 2 is a simplified block diagram of a warrantor's system according to an embodiment of the present invention.

FIG. 3 is a dataflow diagram according to an embodiment of the present invention.

FIG. 4 is a functional block diagram of a defect analysis and resolution unit according to an embodiment of the present invention.

FIG. 5 provides an exemplary data flow according to an embodiment of the present invention.

FIG. 6 is a functional block diagram of a service provider enablement system according to an embodiment of the present invention.

FIG. 7 is a data flow diagram illustrating operations that may be performed by a SPE system during warranty entitlement checks or repair authorization.

FIG. 8 is a simplified block diagram of a computer system.

### DETAILED DESCRIPTION

According to embodiments of the present invention, a warrantor computer system provides automated support functions that permit new and existing customers to enter into warranty agreements, alter existing warranty agreements or change customer profiles to identify new products subject to warranties. The warranty management system further provides a defect analysis and resolution service that compiles warranty claims for statistical analysis to identify product defects. Additionally, the warranty management system provides a service partner enabling service that manages services of partners performed pursuant to a warranty.

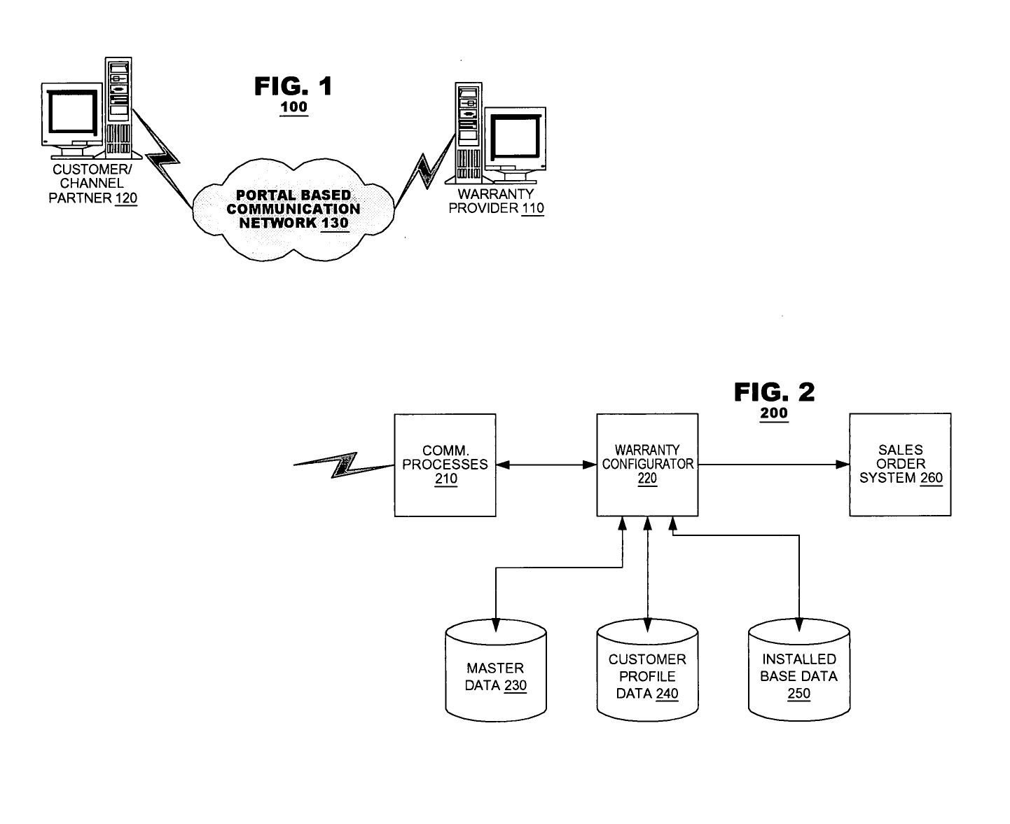

FIG. 1 is a simplified block diagram of a networked computer system useful with embodiments of the present invention. In this embodiment, two computer systems 110, 120 may be provided in mutual communication via a portal-based communication fabric 130. Here, the computer systems may be considered to represent a computer system of a manufacturer and/or warrantor 110 and the computer system of a customer 120. Although the computer systems 110, 120 of FIG. 1 are illustrated as single server stations, their architecture is immaterial to the principles of the present invention except insofar as they are described below.

FIG. 2 is a simplified functional block diagram of a computer system 200 according to an embodiment of the present invention. The warrantor's system 200 may include a communication process 210 devoted to management of portal-based communication with external systems according to various communication protocols as are known in the art. As its name implies, the communication process 210 provides a “portal” through which an external customer may gain access to warranty pricing data, customer profile data and other data items as may be appropriate for the customer. By providing such a portal, the communication process 210 regulates the customer's access to only those data items that relate to the business between the warrantor and the specific customer and to possibly new business operations. The communication process 210 performs customary security and authentication operations to manage external access.

The warranty configurator 220 executes external requests relating to warranty management. For example, the warranty configurator 220 may engage in an online transaction to sell or upgrade a warranty policy. The warranty configurator 220 may perform checks to determine if anticipated repairs are covered by an existing warranty policy. The warranty configurator 220 also may engage in parts sales to customer, both sales that are covered by warranty and those that are not covered by warranty.

The warranty configurator 220 is provided in communication with a series of databases 230-250 to support its operation. A first database 230 stores master data, representing for example product pricing information, warranty policy terms and/or product information. A second database 240 stores data representing customer accounts. A third database 250 stores data representing an installed base of products and warranty policies that may apply to them. The warranty configurator 220 also may be provided in communication with a sales order system 260 to execute sales of warranty products and/or product parts. Sales order systems 260 are conventional components of enterprise resource planning systems.

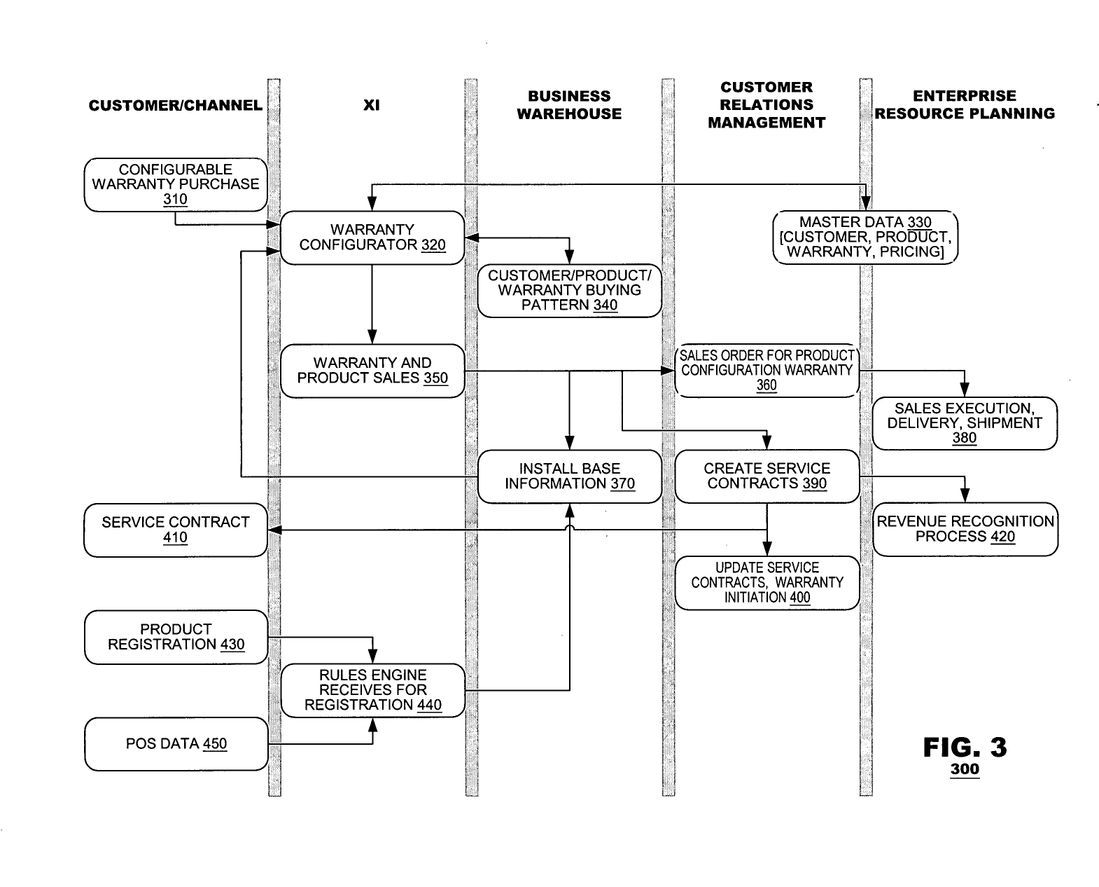

FIG. 3 is a dataflow diagram according to an embodiment of the present invention. Operation of the system may begin when, for example, the warrantor's system receives a request for a configurable warranty purchase from some external customer (box 310). In response to the request, the system may engage a warranty configurator process (box 320), which manages the warranty purchase. The warranty configurator 320 may retrieve master data (box 330) representing terms, conditions and pricing of various goods sold by the warrantor, warranty products sold by the warrantor either on their own or in combination with the warrantor's goods, and also various conditions on which the warranty products may be offered to specific customers. The warranty configurator 320 additionally may retrieve customer specific information (box 340) representing, for example, buying patterns of the customer. From such data sources, the warranty configurator 320 may determine which of the warranty products the customer is eligible to purchase.

A product sales unit (box 350) manages product and warranty sales. It collects sales information from the customer via the warranty configurator 320 and causes a sales order to be generated for new product(s) (box 360). If the sales order is made in conjunction with product purchases, the sales order process 360 further may cause a sales execution process (box 370) to execute the sale, schedule delivery or purchased goods and the like. The sales unit 350 also may add information regarding purchased products to an installed base of products for the customer (box 380).

The product sales unit 350 also may create service contracts representative of a purchased warranty (box 390). Thereafter, the system 300 may add the service contracts to a customer profile (box 400) and transmit records of the service contract(s) back to the customer (box 410). The system also may store data regarding the warranty purchase to a revenue recognition process (box 420). Revenue recognition may provide a foundation for financial analyzers to determine, based on a comparison with claims data, whether current warranty programs are profitable enterprises for the warrantor.

In another embodiment, a customer portal may be provided through which a customer may register products purchased through third party retailers and other sources (box 430). In such an embodiment, a rules engine (box 440) may solicit customer information sufficient to register a new product and initiate a basic warranty for that product. During product registration, the customer may be provided an opportunity to configure an extended warranty for the product or for a deployed base of products. If the customer pursues the opportunity, the warranty configurator 320 may be engaged for further processing a described above.

Additionally, product registration and basic warranty provision may occur from point of sale (POS) data (box 450). The rules engine 440 may solicit customer information sufficient to register the new product from a POS data source, typically found at retail locations. At this time, a customer may be provided an opportunity to configure an extended warrant for the product or for a deployed base of products. Again, if the customer pursues the opportunity, the warranty configurator may be engaged for further processing as described above.

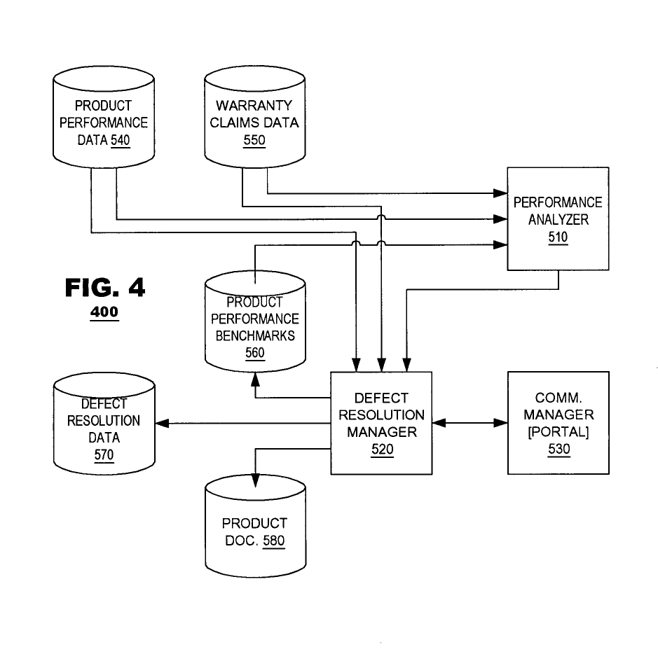

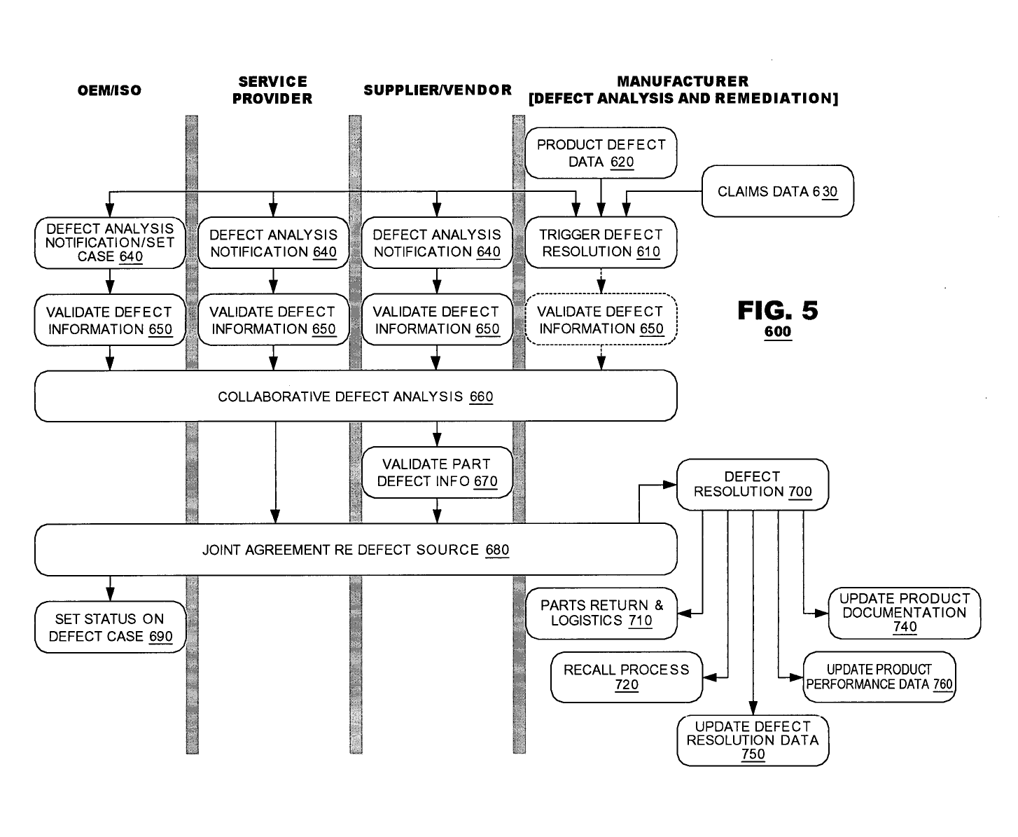

FIG. 4 is a functional block diagram of a defect analysis and resolution unit according to an embodiment of the present invention. As illustrated, the DAR 500 may include a performance analyzer 510, a defect resolution manager 520 and a communication manager 530. The DAR 500 also may include several data elements, storing product performance data 540, warranty claims data 550, product performance benchmarks 560, defect resolution data 570 and technical manual data 580.

The product performance database 540 stores information regarding product failures or repairs. Product performance data may be gathered from sources such as repair service providers and parts centers (as appropriate for a given product). It may store data representing a product's serial number, dates and types of repairs performed on a given product, dates and types of maintenance performed and any causes noted for product failure. Product performance data may be stored in the product performance database 540 from other systems (not shown).

The warranty claims database 550 may store data representing warranty claims made with respect to each product. The warranty claims database may store information similar to the product performance database 540, noting products' serial numbers, types of repairs sought, types of maintenance performed and causes noted for product failure. The warranty claims database 550 also may indicate whether an owner's claim was covered by a warranty or not. Warranty claims data may be stored in the database 550 via other systems, such as a claims management system (not shown).

The product performance benchmarks database 560 may store data identify product performance expectations. For example, for various components within a product, the benchmarks database 560 may include data identifying an expected lifecycle or a mean time between failures (MTBF). The benchmarks database 560 may identify, on a percentage basis for example, components that are expected to be functional for identified periods of time (e.g., 95% operational two years from date of sale, 75% operational four years from date of sale, etc.).

The product analyzer 510 is an analytical tool that compares actual product performance to performance benchmarks to determine whether recorded data regarding distributed products (as recorded in databases 540, 550) is consistent with expectation benchmarks (represented in database 560). If the performance analyzer detects abnormal performance with respect to a product as a whole or a product component, it may engage the defect resolution manager 520.

The defect resolution manager 520 represents functionality sufficient to diagnose and remediate possible product defects. It may engage the communication manager 530 to exchange product performance data with computer systems of other participants in a product's distribution chain (e.g., systems of distributors, service/repair organizations and product vendors).

The defect resolution manager 520 may perform analytical operations to classify abnormal product behavior according to various metrics. Essentially, using statistical techniques, the defect resolution manager may identify, for example, that a significant portion of product defects is localized in a particular product component. Alternatively, the defect resolution manager may identify that a significant portion of product failures occurs from products that are serviced by a particular repair organization. Hypothetically, the defect resolution manager may determine that a significant percentage of product failure occur through product misuse.

Product performance data models individual distributed products according to a number of different metrics, including for example, mean time between failure (MTBF), mean time to repair (MTTR), “wrench-time,” product defect codes (component failure, user error). The defect resolution manager 520 may run statistical analyses of such performance data to determine whether product failures can be clustered according to one or more object fields.

As noted, the defect resolution manager 520 may facilitate an exchange of data collaboratively with other systems for other participants in a product's distribution chain. The defect resolution manager 520, for example, may exchange product performance data with these other systems and receive product performance data regarding the same products or some other set of products where similar product failures are noted, to provide a universal set of performance data for analysis. Having supplemented the product performance data, clustering algorithms run by the defect resolution manager 520 may be applied.

When a product defect is isolated, the defect resolution manager 520 may generate resolution data to facilitate resolution of a product defect. For example, the defect resolution manager may amend data in the product performance benchmarks to revise product performance expectations if the expectations are determined to have been erroneous. Based on the type of defect noted, the defect resolution manager 520 may store data in a product documentation database 580 identifying kinds of product mis-use that have contributed to product failures. Such notes may be used to revise product documentation or technical manuals for products that are newly released. Further, depending on severity of product defects that are observed, the defect resolution manager may invoke a notification process (not shown) to generate alert notifications to product owners registered with the system.

The defect resolution manager 520 also may store data in a defect resolution database 570 that represents a cause of product failure and remedial steps. In so doing, the defect resolution manager 520 may generate a resolution history with respect to the product. Such resolution histories may be useful for a firm as it decides to renew relationships with product vendors, service firms and the like. For example, if a firm's defect resolution manager 520 received multiple notifications that a product component was the source of a product defect notwithstanding notifications sent to the component's manufacturers, a firm might consider finding an alternate supply of the unreliable components. Similarly, if a service organization were the source of product defect complaints because of faulty repair and continued to be a source of complaints following notice, again the firm might consider finding an alternative repair firm. The defect resolution database 570 therefore may store objects representing operations performed by the defect resolution manager, storing performance data that triggered the defect resolution manager, performance statistics that revealed the source of the product defects and any resolution performed (e.g., notification to others, revisions to product documentation, design defects).

FIG. 5 provides an exemplary data flow of a DAR unit and associated components according to an embodiment of the present invention. Although the DAR unit is illustrated as being a component within a manufacturer's computer system, the DAR unit may be provided in any other system illustrated in FIG. 5 or even in systems of multiple participants.

According to an embodiment of the present invention, a defect resolution process 610 may be triggered by internal analyses of product defect data 620 or warranty claims data 620 but also by a defect notification 640 received from an external agent. In one embodiment, a defect notification 640 generated by any agent (say, the ISO) may be transmitted to every agent (the manufacturer, service providers and suppliers) in the distribution chain either directly or through a notification relay mechanism. For example, the service provider may notify a manufacturer of a defect and the manufacturer may notify suppliers and OEMs or ISOs. This may cause an OEM or ISO to set a defect resolution case.

Upon reception of a notification, the various agents may perform their own validation processes 650 to ensure that the defect notification actually relates to products for which they are responsible. Of course, a supplier need not engage in defect resolution for a component part that it does not manufacture. Following successful validation, the agents may engage in collaborative defect analysis 660.

Collaborative defect analysis 660 involves data exchange among the various agents to permit product performance analysis. As noted, the various agents may store product performance data along different data parameters. The agents may publish the parameters and the product performance data to each other to provide a broader set of data for defect analysis. The defect analysis 660 may identify a particular component part as a source of the product defect, in which case a supplier of the component may validate the component part (box 670) to confirm that it supplied the defective product. The defect analysis may conclude when each of the agents publish results from their own defect analyses and they agree 680, identifying a cause of the defect. When the defect analysis concludes, the OEM/ISO may set a new status on its defect case 690.

When the defect analysis concludes, the DAR system may engage a defect resolution process 700. The defect resolution process may engage other business processes performed by the manufacturer's computer system, such as a parts return and logistics process 710 to manage ordering of parts to repair the defective product. Depending on severity of the product defect and the extent to which it appears within the population of distributed products, the defect resolution process 700 may engage a recall process 720 to recall products in which the defect has not been detected. As noted, the defect resolution process 700 may update product performance data to reflect the product defect in its databases 730. If the defect analysis process identified product misuse as a likely cause of the product defect, the defect resolution process 700 may store update its database of technical information 750 indicating a need possibly to revise the manufacturer's product documentation to identify proper uses of the product. Finally, the defect analysis process 700 may update its defect resolution database 750 to add the identified defect to a log of product defects and to indicate diagnosed causes of the defect and resolution taken.

Consider operation of the DAR system in the context of a hypothetical product, a CT simulator device to be used in cancer treatment via radiation therapy. For purposes of this example, it may be assumed that the product includes three modules (modules 1-3) of which module 3 is the most expensive and also subject to compliance regulations. The product may have an expected availability rate of 99%, due to expense of other factors. The product may be assigned a serial number of 1000, module 1 may have a serial number 10001, module 2 may have a serial number 10002 and module 3 may have a serial number 10003. The product may be owned and operated by an OEM that captures performance data using a computer system equipped with a DAR according to the foregoing embodiments.

During the course of operation, the OEM may capture performance data. Performance data may be compared against the expected availability rate or against other performance indicators (e.g., trigger a defect case upon the 10ₜₕ product outage within a predetermined period of time). The OEM system may alert other parties in the market (manufacturers, component suppliers and service personnel (on site engineers)) of the defect case.

Responsive to the defect case, the other parties may supply additional performance data. For example, module supplier(s) may supply history data such as mean times between failures of the product components. An on site engineer may provide usage data for the product. Such information may be provided manually from these other parties or through automated data exchange protocols. Additionally, the defect system may retrieve the history of repair for the product. The defect system also may identify a possible resolution, for example, that one of the modules has an incompatible component.

Responsive to the resolution, the system may generate an alert for a design engineering team within the firm. The system also may initiate a notification for a recall and replacement of the defective module. Moreover, the system may identify a parts supplier of an impending recall and also about the compatibility issues. Finally, the system may update historical performance data and defect databases before closing the case status.

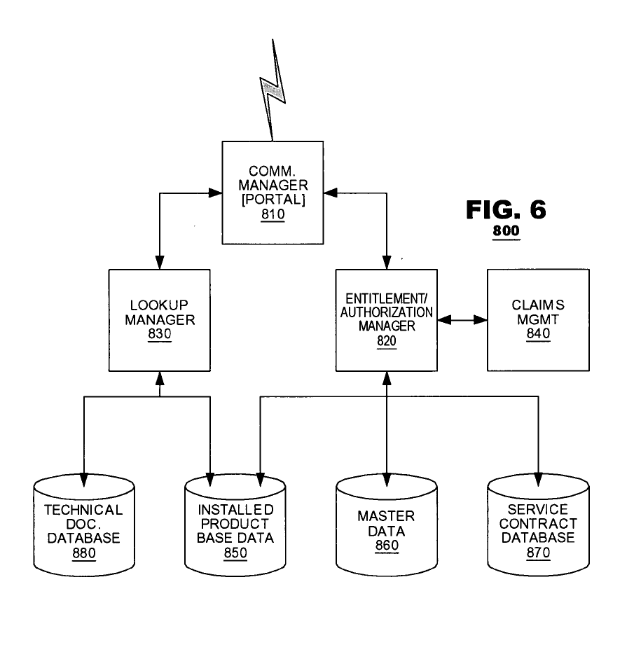

FIG. 6 is a functional block diagram of a service provider enablement (“SPE”) system 800 according to an embodiment of the present invention. As illustrated the SPE system 800 may include a communication manager 810, an entitlement/authorization manager “EAM”) 820, a lookup manager 830 and a claims management system 840. The communication manager 810, as its name implies, manages portal-based communication services with servers from computer networks of various service providers. Alternatively, data exchange may occur through an electronic document exchange such as those facilitated by extensible markup language (“XML”). The communication manager 810 authenticates new requests received from service providers and manages the service providers' access to data structures within the SPE system 800. The communication manager may forward requests as appropriate to the EAM 820 or the lookup manager 830.

The EAM 820 responds to service requests and inquiries from service providers. It is supported by databases that store data regarding an installed base of products delivered throughout the marketplace (250), a database of master data 860 and a service contract database 870 that stores data representing parameters of various service contracts to which the warrantor is engaged. In response to service requests, the EAM 820 also may engage a claims management unit 840, which processes claims and engages other systems (not shown) to fulfill parts shipment and process financial reimbursement. Claims management systems are well-known. For example, SAP AG, the assignee of the present application currently includes claim management systems as part of its customer relations management (“CRM”) system and its R/3 system.

The lookup system 830 may respond to requests for information that do not require comparison against service contracts or warranty policies. The lookup system 830 may be supported by the installed product base database 850 and by a technical documentation database 880.

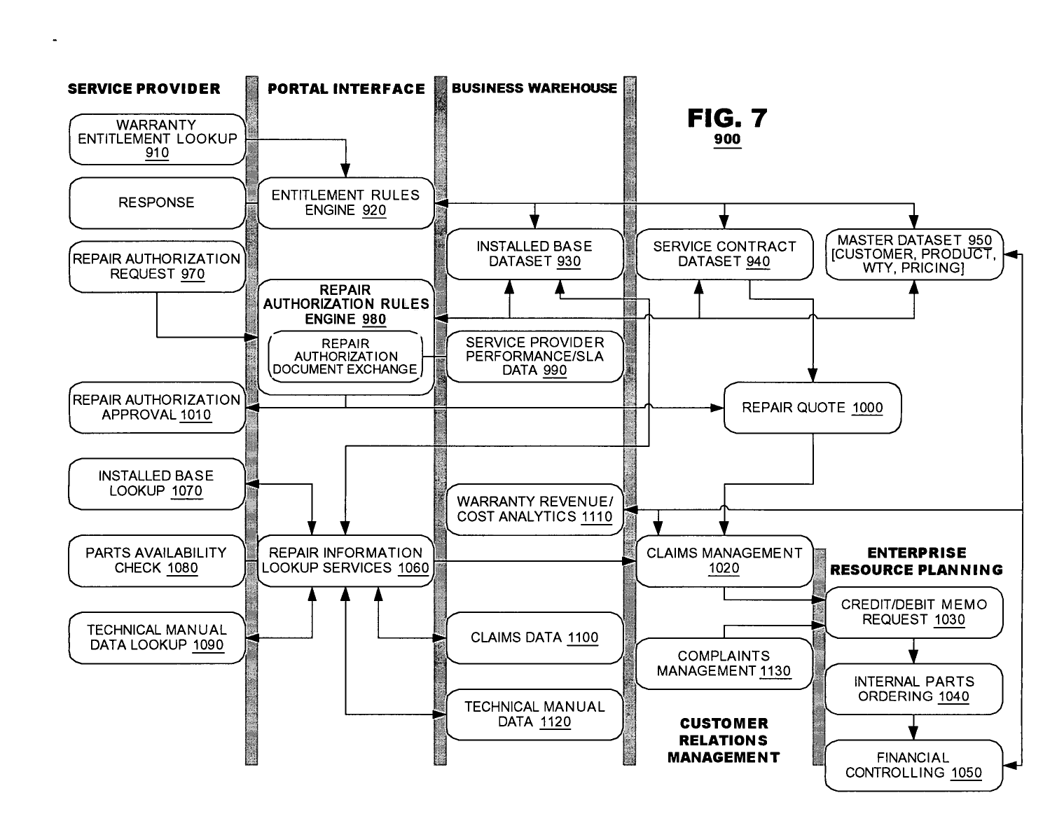

FIG. 7 is a data flow diagram 900 illustrating operations that may be performed by a SPE system during warranty entitlement checks or repair authorization. To determine whether an anticipated repair is covered by a warranty, a service provider may submit a warranty entitlement lookup request that includes a product identifier (typically a serial number or warranty policy number) and a repair identifier (box 910). The repair identifier may include a predetermined code that identifies the type of repair to be performed or a part number identifying a component being replaced or repaired.

Responsive to the entitlement lookup request, an entitlement rules engine authenticates the request and compares the repair identifier to parameter data representing a governing warranty. The entitlement rules engine 920 may refer the product identifier to an installed base dataset, which records information regarding products deployed in the marketplace (box 930). If the product identifier does not match any record present in the installed base dataset 930, the request will not be authenticated. If a match occurs, the installed base dataset 930 delivers a customer record identifying a warranty service contract under which the product is covered. Based on the customer record, the entitlement rules engine 920 may retrieve parameter data from a service contract dataset (box 940), from which the entitlement rules engine 920 may determine whether the identified service is covered under the service contract. Further, the entitlement rules engine 920 may retrieve warranty information from a master dataset (box 950), from which the entitlement rules engine 920 may determine whether the requested repair is covered by warranty or not. The entitlement rules engine evaluates the requested repair type against parameters of any service contract or warranty policy that governs over the product and generates a response (box 960) to the service provider, which indicates whether the requested repair may be performed within the scope of either a service contract or a warranty.

Before a repair may be performed, a service provider may submit a repair authorization request to the warrantor (box 970). As with the entitlement request, the authorization request may identify the product to be repaired and a repair to be performed. A repair authorization rules engine (box 980) may compare the product identifier to the installed base dataset (box 930) to authenticate the product. The repair authorization rules engine 980 also may interface with the service contract dataset 940 and master data 950 to retrieve service agreement and warranty parameter data and authenticate the request.

Additionally, the repair authorization rules engine 980 may refer to a service provider dataset 990 to authenticate the service provider from whom the authorization request is received. Warrantors may limit the scope of repairs that they authorize service providers to perform based upon the service providers' past performance, cost relative to other service providers, geographical locations and/or service response time. Service provider authentication 990 manages such functions.

If the repair authorization request is granted, the repair authorization rules engine 980 may cause a repair quote to be generated 1000 and provided to the service provider's system in a repair approval response (box 1010). The SPE system also may pass the repair quote 1000 to a claims management system 1020 therein. The claims management system 1020 performs parts availability checks for the requested repair and provides a portal for the service provider to check on processing of the service claim (communication path not shown in FIG. 7). The service provider, for example, can check on delivery dates for shipped products and the like which may be necessary to complete repairs of the product.

The SPE system may include a credit/debit memo request system 1030 that tracks billing and other financial aspects of recovery or payment that may be necessary by the warrantor. For example, if the warrantor is a retailer that sells other manufacturer's products under its own label, the warrantor may be entitled to recover from the manufacturer for warranty claims that indicate defective products. Similarly, if the SPE system manages affairs for a manufacturer but warranty claims are made to a retailer, the manufacturer may be required to reimburse the retailer for such claims. The credit/debit memo system may manage collection and reporting of such claims data.

The SPE system also may include an internal parts ordering system 1040. The internal ordering system 1040 may manage parts replenishments for inventory purposes. Often, warrantors establish policies require establishment and maintenance of a stockpile of product parts on an ongoing basis. When the warrantor ships a part to satisfy a repair request, for example, the internal parts ordering system 1040 may order a replacement part to replenish its supplies. Stockpile levels may be established differently for different geographic regions and may vary based on observable product performance. Thus, the internal parts ordering system 1040 maintains an ongoing inventory of products to satisfy anticipated repair claims.

The SPE system may include a financial controller 1050 to capture costs associated with repair requests. The controller 1050 may captures all costs including parts and labor, warranty costs collection, payouts and reimbursement. The financial controller also may manage funds for a warranty reserve fund, a pool of funds dedicated to payment of warranty claims.

The SPE system also may provide service provides access to information to assist them in scheduling and performing their repairs. The system may provide lookup services (box 1060) to authorized service providers via its portal interface, which may permit service providers to survey an installed product base for its customers (box 1070), to check on parts and their availability (box 1080) and also to lookup technical information regarding products (box 1090).

For example, in response to an installed base lookup request 1070 that identifies a customer, the SPE system may survey its database of installed products 930 to identify products owned by a common customer. This may prove convenient for customers that own multiple deployed products. When a service provider is requested to perform maintenance on one piece of a customer's equipment, the service provider may determine whether the customer owns other similar products that should be serviced as part of a preventative maintenance effort.

In response to a request to check on parts availability, the lookup services module 1060 may interface with the claims management system 1020 to determine whether parts are available. The claims management system 1020 may provide shipping information regarding a requested product and provide tracking information to permit the service provider to estimate a date on which parts will become available at its facilities.

In response to a request for technical information, the lookup services 1060 may engage a technical documentation database 1100 to retrieve and deliver product information to the service provider.

The SPE system also may include a warranty revenue/cost analytics module 1110 to assess warranty programs in place and to determine whether the warranty program is a revenue generating program for the warrantor. The warranty module 1110 is provided access to financial information representing revenues from sales of extended warranties and service plans and also representing costs associated with repair claims that fall under the service contracts. The analytics engine may analyze various repair requests by type and cluster them according to warranty/service agreement provisions to which the repairs relate. In this manner, the analytics engine may help to identify provisions of the warranty agreements or service agreements that are particularly costly or profitable to implement. Such information may become particularly useful for review by the warranty/service agreement policy makers within the warrantor's organization.

The SPE system may include a complaints management unit 1120 to log customer complaints regarding service provided under a warranty agreement or service agreement.

The foregoing operations may be allocated across various systems of a warrantor's computer system. SAP AG, for example, currently sells various products such as a customer relations management system, a business warehouse system and an enterprise resource planning system. In an embodiment, functionality of the service enablement system 900 may be distributed across these systems as shown in FIG. 7.

Some of the functionality of the foregoing embodiments may be provided by an integrated systems landscape provided by automated infrastructure support applications, such as business warehouse (BW), customer relations management (CRM) and enterprise resource planning (ERP) systems. For example, sales management functions per se are provided by existing CRM system. Maintenance of customer data, product pricing data and warranty data can be provided by CRM and/or ERP systems. Accordingly, the foregoing embodiments may leverage such existing systems to provide new functionality as described hereinabove.

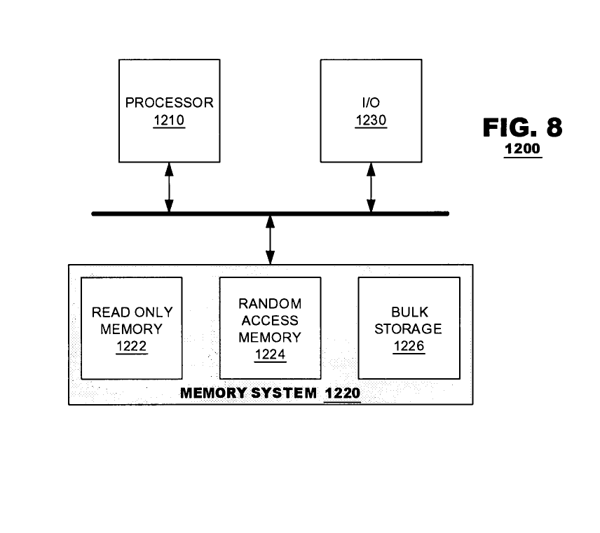

As noted, functionality of the foregoing embodiments may be provided on various computer platforms executing program instructions. One such platform 1200 is illustrated in the simplified block diagram of FIG. 8. There, the platform 1200 is shown as being populated by a processor 1210, a memory system 1220 and an input/output (I/O) unit 1230. The processor 1210 may be any of a plurality of conventional processing systems, including microprocessors, digital signal processors and field programmable logic arrays. In some applications, it may be advantageous to provide multiple processors (not shown) in the platform 1200. The processor(s) 1210 execute program instructions stored in the memory system. The memory system 1220 may include any combination of conventional memory circuits, including electrical, magnetic or optical memory systems. As shown in FIG. 4, the memory system may include read only memories 1222, random access memories 1224 and bulk storage 1226. The memory system not only stores the program instructions representing the various methods described herein but also can store the data items on which these methods operate. The I/O unit 1230 would permit communication with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1. A warranty management system, comprising:
a communication unit,
a warranty sales unit to manage sales of warranty policies to customers via the communication unit,
a service partner enabling unit, to exchange claims data with service partners via the communication unit,
a defect analysis unit to analysis claims data stored by the system to identify product defects therein.

2. The warranty management system of claim 1, wherein the communication unit supports a portal-based communication interface.

3. The warranty management system of claim 1, wherein the communication unit supports a document-based communication interface.

4. The warranty management system of claim 1, wherein the warranty sales unit comprises:
a warranty configurator to interface with the customer via the communication unit,
a master data database storing data representing warranty policy terms, pricing information and product data.

5. The warranty management system of claim 4, further comprising a sales order system in communication with the warranty configurator.

6. The warranty management system of claim 1, wherein the defect analysis unit comprises:
a first database storing actual product performance data,
a second database storing expected product performance data,
a defect analyzer,
a performance analyzer to engage the defect analyzer based on a comparison of data from the actual product performance database and the expected product performance database, and
a defect resolution database to store data generated by the defect analyzer.

7. The warranty management system of claim 1, wherein the service partner enabling unit comprises:
a first database representing a base of installed products, records therein including an customer identifier,
a second database storing data records representing warranty plan parameters applicable to customers,
an entitlement manager, responsive to an entitlement lookup request received from the communication portal, to
retrieve customer data from the first database,
based on the customer identifier, retrieve warranty plan parameters from the second database,
compare an identifier of a repair type against the warranty plan parameters, and
generate a response to the entitlement lookup request indicating whether the repair type is valid based on the warranty plan parameters.

8. A warranty management method, comprising:
exchanging data with a customer terminal representing inquiries and responses pursuant to a warranty sales transaction,
responsive to an inquiry, retrieving warranty terms data from a database and transmitting the warranty terms data to the customer terminal,
responsive to an inquiry, retrieving warranty pricing data from a database and transmitting the warranty pricing data to the customer terminal,
responsive to a purchase inquiry, initiating a sales order process for a selected warranty.

9. The warranty management method of claim 8, wherein the exchanging occurs via a portal-based communication interface.

10. The warranty management method of claim 8, wherein the exchanging occurs via a document-based communication interface.

11. The warranty management method of claim 8, wherein the customer terminal is a POS terminal.

12. The warranty management method of claim 8, further comprising receiving product registration data from the customer terminal.

13. The warranty management method of claim 8, further comprising responsive to a warranty claim made under the selected warranty, generating a defect analysis notification to other agents,
exchanging product performance data with the other agents,
performing a defect analysis upon the exchanged product performance data, and
responsive to the defect analysis, storing defect resolution data in a database.

14. The warranty management method of claim 8, further comprising
responsive to a repair authorization request identifying the selected warranty, retrieving customer data from a database of installed products by a customer identifier,
based on the customer identifier, retrieving from storage a data record representing warranty plan parameters applicable to the customer,
comparing an identifier of a repair type against the warranty plan parameters, and
generating a repair quote if the repair type is valid based on the warranty plan parameters.

15. Computer readable medium storing program instructions that, when executed by a processing device, cause the device to:
exchange data with a customer terminal representing inquiries and responses pursuant to a warranty sales transaction,
responsive to an inquiry, retrieve warranty terms data from a database and transmitting the warranty terms data to the customer terminal,
responsive to an inquiry, retrieve warranty pricing data from a database and transmitting the warranty pricing data to the customer terminal,
responsive to a purchase inquiry, initiate a sales order process for a selected warranty.

16. The medium of claim 15, wherein the device comprises a portal-based communication interface.

17. The medium of claim 15, wherein the device comprises a document-based communication interface.

18. The medium of claim 15, wherein the customer terminal is a POS terminal.

19. The medium of claim 15, wherein program instructions further cause the device to receive and store product registration data from the customer terminal.

20. The medium of claim 15, wherein program instructions further cause the device to
generate a defect analysis notification to other agents in response to a warranty claim made under the selected warranty,
exchange product performance data with the other agents,
perform a defect analysis upon the exchanged product performance data, and
responsive to the defect analysis, store defect resolution data in a database.

21. The medium of claim 15, wherein program instructions further cause the device to
retrieve customer data from a database of installed products by a customer identifier in response to a repair authorization request identifying the selected warranty,
based on the customer identifier, retrieve from storage a data record representing warranty plan parameters applicable to the customer,
compare an identifier of a repair type against the warranty plan parameters, and
generate a repair quote if the repair type is valid based on the warranty plan parameters.
